(19) United States
(12) Patent Application Publication
(10) Pub. No.: US 2019/0121205 A1
(43) Pub. Date: Apr. 25, 2019

(54) LIQUID CRYSTAL DEVICE AND METHOD FOR MANUFACTURING THE SAME

(71) Applicant: Samsung Display Co., Ltd., Yongin-si (KR)

(72) Inventors: Israel Esteban Lazo Martinez, Hwaseong-si (KR); Kyeong Jong Kim, Suwon-si (KR); Heung Shik Park, Seoul (KR); Ki Chul Shin, Seongnam-si (KR)

(21) Appl. No.: 15/948,470

(22) Filed: Apr. 9, 2018

(30) Foreign Application Priority Data
Oct. 20, 2017 (KR) 10-2017-0136469

(51) Int. Cl. G02F 1/1343; G02F 1/1362; G02F 1/1335; G02F 1/1337

(52) U.S. Cl. CPC G02F 1/134309; G02F 1/1368; G02F 1/133617; G02F 1/133504; G02F 1/133711; G02F 1/133788; G02F 1/133753; G02F 1/133707; G02F 2001/136218; G02F 2201/122; G02F 2201/123; G02F 1/136227; G02F 1/136209; G02F 2202/108; G02F 1/136286

(57) ABSTRACT

A liquid crystal display including a liquid crystal panel including: a gate line and a data line disposed on a first substrate; a transistor connected to the gate line and the data line; a pixel electrode connected to the transistor; a second substrate facing the first substrate; red and green color conversion layers and a transmission layer disposed on one surface of the second substrate; a common electrode disposed on one surface of the red and green color conversion layers and the transmission layer; and a liquid crystal layer including liquid crystal molecules disposed between the first and second substrates. The data line is disposed adjacent to one edge of the pixel electrode, and an arrangement of liquid crystal molecules disposed at a part corresponding to the data line is the same as an arrangement of liquid crystal molecules of a part corresponding to the pixel electrode.

### CROSS-REFERENCE TO RELATED APPLICATION

This application claims priority from and the benefit of Korean Patent Application No. 10-2017-0136469, on Oct. 20, 2017, which is hereby incorporated by reference for all purposes as if fully set forth herein.

### BACKGROUND

### Field

Exemplary embodiments of the inventive concepts relate to a liquid crystal display and a manufacturing method thereof.

### Discussion of the Background

As one of the most widely used type of flat panel displays (FPDs) at present, liquid crystal displays (LCDs) include two display panels formed with electric field generating electrodes, and a liquid crystal layer interposed between the two display panels. The LCD is realized by applying a voltage to electrodes and realigning liquid crystal molecules of a liquid crystal layer so as to adjust an amount of transmitted light.

Among the liquid crystal displays currently in use, a vertical alignment (VA) mode LCD, which aligns LC molecules such that their long axes are perpendicular to the panels in the absence of an electric field, is popular because of its high contrast ratio and wide reference viewing angle. Here, the reference viewing angle is understood to be a viewing angle that is 1:10 in contrast ratio, or a critical angle of gray-to-gray luminance reversion.

In order to obtain a quick response speed of the liquid crystal display, various initial alignment methods for pretilting liquid crystal molecules have been proposed. Among the various initial alignment methods, in an alignment method in which prepolymers polymerized by light such as ultraviolet rays are used to pretilt the liquid crystal molecules, the field generating electrodes are respectively applied with desired voltages and are then exposed to the light.

When initially aligning the liquid crystal molecules, transmittance may be reduced at an edge part of a pixel electrode as one among the field generating electrodes.

The above information disclosed in this Background section is only for enhancement of understanding of the background of the invention and therefore it may contain information that does not constitute prior art.

### SUMMARY

Exemplary embodiments of the inventive concepts are intended to improve transmittance of the liquid crystal display.

Additional features of the inventive concepts will be set forth in the description which follows, and in part will be apparent from the description, or may be learned by practice of the inventive concepts.

A liquid crystal display according to an exemplary embodiment of the inventive concepts includes a liquid crystal panel and a light source assembly supplying light to the liquid crystal panel. The liquid crystal panel includes: a gate line and a data line disposed on a first substrate and insulated from each other; a transistor connected to the gate line and the data line; a pixel electrode connected to the transistor; a second substrate facing the first substrate; a red color conversion layer, a green color conversion layer, and a transmission layer disposed on one surface of the second substrate; a common electrode disposed on one surface of the red color conversion layer, the green color conversion layer, and the transmission layer; and a liquid crystal layer disposed between the first substrate and the second substrate and including a plurality of liquid crystal molecules. The data line is disposed adjacent to one edge of the pixel electrode, and an arrangement of liquid crystal molecules disposed at a part corresponding to the data line is the same as an arrangement of liquid crystal molecules of a part corresponding to the pixel electrode.

The pixel electrode may include a first stem part and a second stem part crossing each other, a minute branch part extending from the first stem part and the second stem part, and four sub-regions divided by the first stem part and the second stem part.

The arrangement of liquid crystal molecules disposed at a part corresponding to the data line may be the same as an arrangement of liquid crystal molecules disposed at each sub-region of the pixel electrode disposed adjacent to the data line.

The liquid crystal display may further include: a reference electrode line disposed on the first substrate and disposed on the same layer as, and separated from, the gate line; and a shielding electrode disposed on the same layer as the pixel electrode and including the same material as the pixel electrode, where the shielding electrode overlaps the data line.

The red color conversion layer and the green color conversion layer may include quantum dots.

At least one among the red color conversion layer, the green color conversion layer, and the transmission layer may include a scattering member.

The transmission layer may not include the quantum dots.

The light source assembly may supply blue light to the liquid crystal panel.

A method of manufacturing a liquid crystal display according to an exemplary embodiment of the inventive concepts includes: forming a first display mother glass including a first substrate, a gate line, and a reference voltage line disposed on the first substrate and separated from each other, a data line insulated from the gate line and the reference voltage line, a transistor connected to the gate line and the data line, a pixel electrode connected to the transistor, and a shielding electrode disposed on the same layer as the pixel electrode and separated from the pixel electrode; forming a second display mother glass including a second substrate, and a first common electrode and a second common electrode disposed on the second substrate and separated from each other; forming a liquid crystal layer including a plurality of liquid crystal molecules on the first display mother glass or the second display mother glass; adhering the first display mother glass and the second display mother glass; applying a voltage to the first display mother glass and the second display mother glass to form an electric field to the liquid crystal layer; and irradiating ultraviolet rays to the liquid crystal layer to which the electric field is formed to initially align the liquid crystal molecules. When forming the electric field to the liquid crystal layer, a voltage applied to the gate line and the data line is greater than a voltage applied to the reference voltage line, and a voltage applied to the reference voltage line is greater than a voltage applied to the shielding electrode.

The first display mother glass may further include: a first pad, a second pad, a third pad, a fourth pad, a fifth pad, a sixth pad, and a seventh pad disposed on the first substrate; a resistor unit electrically connected to the third pad; a driving gate line connecting the second pad and the gate line; a driving data line connecting the fourth pad and the data line; a driving reference voltage line connecting the fifth pad and the reference voltage line; and a driving shielding electrode line connecting the sixth pad and the shielding electrode.

The second display mother glass may further include an eighth pad and a ninth pad disposed on the second common electrode.

The first pad may be electrically connected to the second pad and the eighth pad, the third pad may be electrically connected to the fourth pad and the ninth pad, the fifth pad may be electrically connected to the third pad through the resistor unit, the sixth pad may be electrically connected to the third pad through the resistor unit, the sixth pad may be electrically connected to the seventh pad through the driving shielding electrode line, and the seventh pad may be electrically connected to the first common electrode.

The resistor unit may include a plurality of transistors, and the number of transistors of the resistor unit connected to the fifth pad and the third pad may be less than the number of transistors of the resistor unit connected to the sixth pad and the third pad.

When forming the electric field to the liquid crystal layer, the voltage may be applied to the second common electrode.

The method of manufacturing the liquid crystal display according to an exemplary embodiment of the inventive concepts may further include cutting a part of the first display mother glass and the second display mother glass after initially aligning the liquid crystal molecules. When cutting the part of the first display mother glass and the second display mother glass, the first pad, the third pad, the eighth pad, the ninth pad, the second common electrode, and the resistor unit may be removed.

According to exemplary embodiments, the transmittance of the liquid crystal display may be improved.

It is to be understood that both the foregoing general description and the following detailed description are exemplary and explanatory and are intended to provide further explanation of the inventive concepts as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a view schematically showing one example of a cross-section of a liquid crystal display according to an exemplary embodiment of the inventive concepts.

FIG. 2 is a view schematically showing one example of an arrangement of a pixel of a liquid crystal panel according to FIG. 1.

FIG. 3 is a view schematically showing one example of a cross-section of a liquid crystal panel of FIG. 2 taken along a line III-III′.

FIG. 4 is a view schematically showing one example of a cross-section of a liquid crystal panel of FIG. 2 taken along a line IV-IV′.

FIG. 5 is a view schematically showing an arrangement direction of liquid crystal molecules of a liquid crystal display according to an exemplary embodiment of the inventive concepts.

FIG. 6A and FIG. 6B are views schematically explaining a method of manufacturing a liquid crystal display according to an exemplary embodiment of the inventive concepts.

FIG. 7, FIG. 8, and FIG. 9 are views schematically showing a process for providing a pretilt to liquid crystal molecules by using prepolymers that are polymerized by light, such as ultraviolet rays.

FIG. 10A and FIG. 10B are views schematically shown to explain a method of manufacturing a liquid crystal display according to another exemplary embodiment of the inventive concepts.

FIG. 11A and FIG. 11B are views schematically shown to explain a method of manufacturing a liquid crystal display according to another exemplary embodiment of the inventive concepts.

FIG. 12 is a graph showing a characteristic of transmittance depending on a voltage application during initial alignment of liquid crystal molecules in a method of manufacturing a liquid crystal display according to FIG. 6A and FIG. 6B, and FIG. 11A and FIG. 11B.

FIG. 13 is a graph showing a characteristic of transmittance depending on a voltage application during initial alignment of liquid crystal molecules in a method of manufacturing a liquid crystal display according to FIG. 10A and FIG. 10B.

### DETAILED DESCRIPTION OF THE ILLUSTRATED EMBODIMENTS

In the following description, for the purposes of explanation, numerous specific details are set forth in order to provide a thorough understanding of various exemplary embodiments of the inventive concepts. As used herein “embodiments” are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

To clearly describe the present invention, parts that are irrelevant to the description are omitted, and like numerals refer to like or similar constituent elements throughout the specification.

Further, since sizes and thicknesses of constituent members shown in the accompanying drawings are arbitrarily given for better understanding and ease of description, the present invention is not limited to the illustrated sizes and thicknesses. In the drawings, the thickness of layers, films, panels, regions, etc., are exaggerated for clarity. In the drawings, for better understanding and ease of description, the thicknesses of some layers and areas are exaggerated.

Further, in the specification, the phrase “in a plan view” means when an object portion is viewed from above, and the phrase “in a cross-section” means when a cross-section taken by vertically cutting an object portion is viewed from the side.

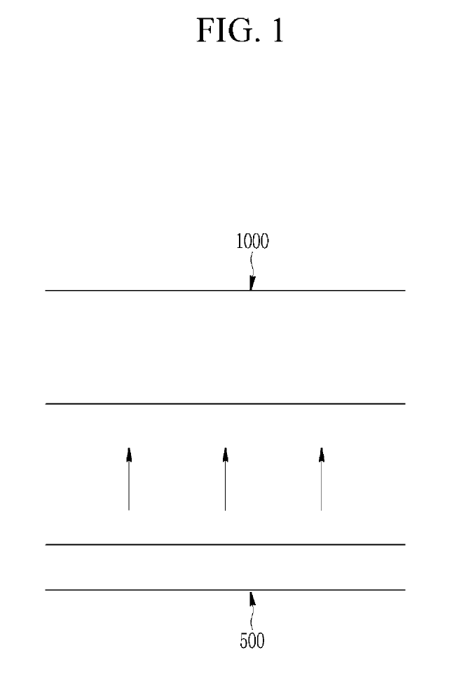

A liquid crystal display according to an exemplary embodiment of the inventive concepts will be described with reference to FIG. 1 to FIG. 5.

FIG. 1 is a view schematically showing one example of a cross-section of a liquid crystal display according to an exemplary embodiment of the inventive concepts.

Referring to FIG. 1, the liquid crystal display according to the present exemplary embodiment includes a liquid crystal panel 1000 and a light source assembly 500.

The liquid crystal panel 1000 may include liquid crystal molecules.

The light source assembly 500 may supply light to the liquid crystal panel 1000, and may include a light source generating light and a light guide (not shown) for receiving light and guiding the received light in the liquid crystal panel 1000 direction.

The light source assembly 500 may emit blue light. The light source assembly 500 may include a blue light emitting diode (LED).

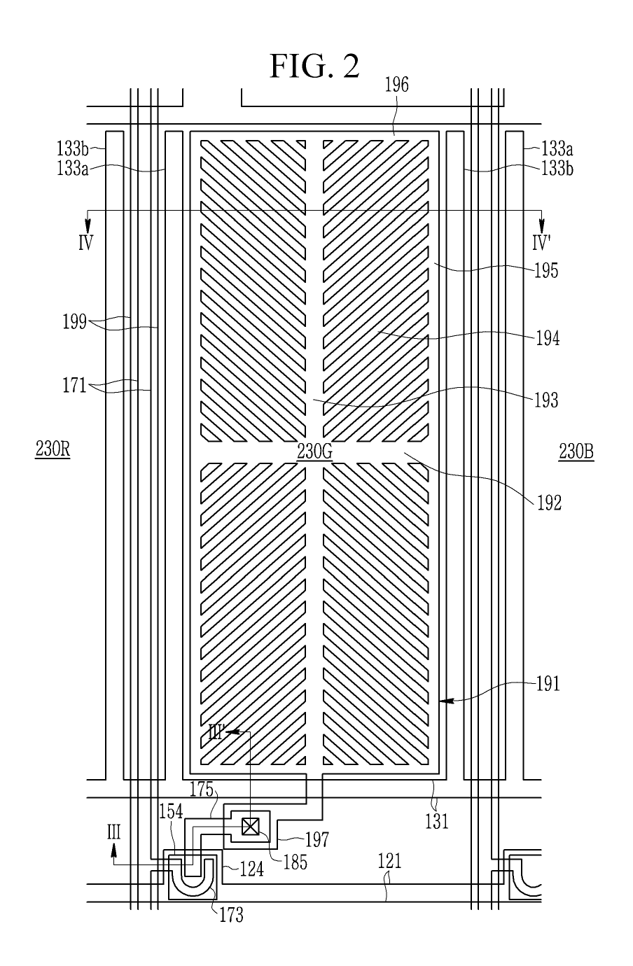

Next, the liquid crystal panel according to an exemplary embodiment of the present invention will be described with reference to FIG. 2 to FIG. 4.

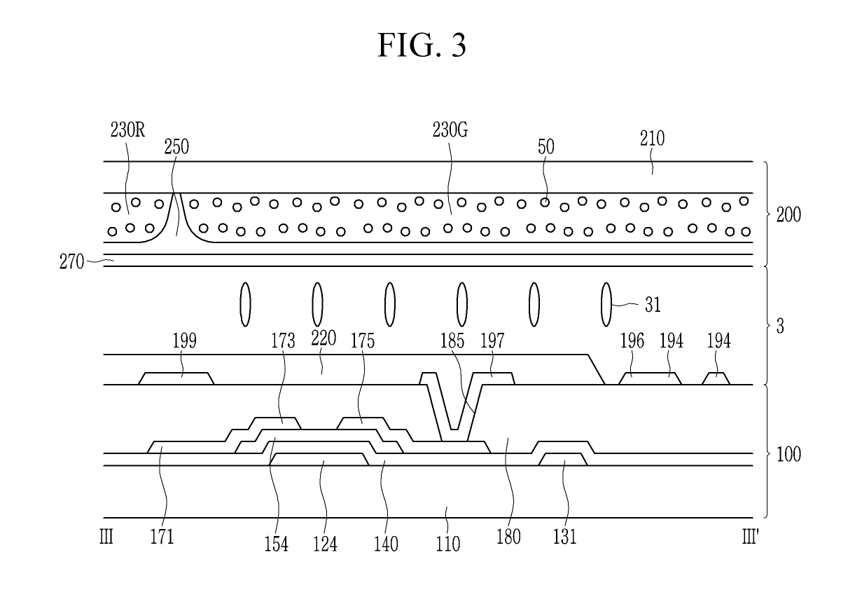

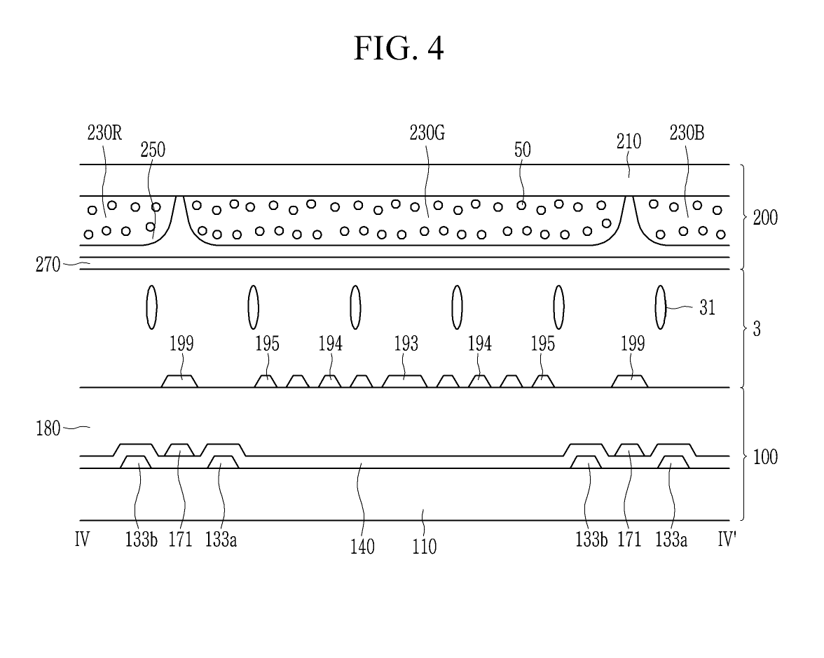

FIG. 2 is a view schematically showing one example of an arrangement of a pixel of a liquid crystal panel according to FIG. 1. FIG. 3 is a view schematically showing one example of a cross-section of a liquid crystal panel of FIG. 2 taken along a line III-III′. FIG. 4 is a view schematically showing one example of a cross-section of a liquid crystal panel of FIG. 2 taken along a line IV-IV′.

Referring to FIG. 2 to FIG. 4, the liquid crystal panel according to the present exemplary embodiment includes a first display panel 100 and a second display panel 200 facing the first display panel 100, and a liquid crystal layer 3 disposed between the first display panel 100 and the second display panel 200.

First, the first display panel 100 will be described.

A gate line 121 and a reference voltage line 131 are disposed on a first insulation substrate 110 that is formed of an insulating material including transmissive glass, plastic, or the like.

The gate line 121 mainly extends in a horizontal direction, transmits a gate signal, and includes a gate electrode 124. The reference voltage line 131 may extend to be parallel to the gate line 121, and includes a first reference electrode 133a and a second reference electrode 133b. The first reference electrode 133a and the second reference electrode 133b may extend in a direction parallel to a data line 171 to be described later.

In the present exemplary embodiment, the gate line 121 and the reference voltage line 131 are formed to have a single-layered structure, but they are not limited thereto, and may be formed to have a dual-layered structure or a triple-layered structure.

A gate insulating layer 140 is disposed on the gate line 121 and the reference voltage line 131. The gate insulating layer 140 may include an inorganic insulating material, such as a silicon oxide (SiOₓ), a silicon nitride (SiNₓ), and the like.

A semiconductor layer 154 is disposed on the gate insulating layer 140. The semiconductor layer 154 overlaps the gate electrode 124 on a plane, and may include amorphous silicon or polycrystalline silicon.

The data line 171 and a drain electrode 175 are disposed on the gate insulating layer 140 and the semiconductor layer 154.

The data line 171 transmits a data signal, mainly extends in a vertical direction, and crosses the gate line 121 and the reference voltage line 131. The data line 171 includes a source electrode 173 extending toward the gate electrode 124 and having a “U” shape. The source electrode 173 is disposed on the gate insulating layer 140 and the semiconductor layer 154.

The drain electrode 175 is disposed to be separat from the data line 171, and extends toward an upper part on a center of the “U” shape of the source electrode 173. The shapes of the source electrode 173 and the drain electrode 175 are only examples and may be variously changed.

In the present exemplary embodiment, the data line 171 and the drain electrode 175 has the single-layered structure, but they are not limited thereto, and may be formed to have the dual-layered structure or the triple-layered structure.

On the other hand, an ohmic contact may be disposed between the semiconductor layer 154, and the source electrode 173 and drain electrode 175. The ohmic contact may reduce contact resistance between the semiconductor layer 154, and the source electrode 173 and drain electrode 175. The ohmic contact may include n+ hydrogenated amorphous silicon doped with an n-type impurity, such as phosphorus (P), at a high concentration.

The gate electrode 124, the source electrode 173, and the drain electrode 175 form a transistor along with the semiconductor layer 154, and the channel of the transistor is formed in the semiconductor layer 154 between the source electrode 173 and the drain electrode 175 and overlaps the gate electrode 124.

A passivation layer 180 is disposed on the gate insulating layer 140, the data line 171, the drain electrode 175, and the channel of the transistor, and the passivation layer 180, includes a contact hole 185 overlapping the drain electrode 175. The passivation layer 180 may be made of inorganic material or organic material. However, the composition of the passivation layer 180 is not limited thereto, and the passivation layer 180 may include a lower layer made of inorganic material and an upper layer made of organic material, for example.

A pixel electrode 191 and a shielding electrode 199 are disposed on the passivation layer 180.

The pixel electrode 191 is connected with the drain electrode 175 through the contact hole 185. The overall shape of the pixel electrode 191 may be a quadrangle including a pair of long sides and a pair of short sides. The pair of long sides of the pixel electrode 191 may extend in the same direction as the extending direction of the data line 171, and the pair of short sides may extend in the same direction as the extending direction of the gate line 121.

The pixel electrode 191 includes a first stem part 192, a second stem part 193, a plurality of minute branch parts 194, a first connection part 195, a second connection part 196, and an extending part 197. The first stem part 192 and the second stem part 193 cross each other, and the plurality of minute branch parts 194 obliquely extend from the first stem part 192 and the second stem part 193.

The pixel electrode 191 is divided into four sub-regions by the first stem part 192 and the second stem part 193 crossing each other. The minute branch part 194 disposed in a left-upper direction of the first stem part 192 and the second stem part 193 obliquely extends from the first stem part 192 and the second stem part 193 in the left-upper direction. The minute branch part 194 disposed in a right-upper direction of the first stem part 192 and the second stem part 193 obliquely extends from the first stem part 192 and the second stem part 193 in the right-upper direction. The minute branch part 194 disposed in a left-lower direction of the first stem part 192 and the second stem part 193 obliquely extends from the first stem part 192 and the second stem part 193 in the left-lower direction. The minute branch part 194 disposed in a right-lower direction of the first stem part 192 and the second stem part 193 obliquely extends from the first stem part 192 and the second stem part 193 in the right-lower direction.

The first connection part 195 extends parallel to the second stem part 193 and is connected to one end of the minute branch part 194. The second connection part 196 extends parallel to the first stem part 192 and is connected to one end of the minute branch part 194.

The pixel electrode 191 is connected to the drain electrode 175 through the contact hole 185 at the extending part 197, thereby receiving a data voltage from the drain electrode 175.

The shielding electrode 199 includes the same material as the pixel electrode 191, and overlaps the data line 171 on a plane. A width of the shielding electrode 199 is greater than the width of the data line 171. The shielding electrode 199 receives a voltage that is applied to a common electrode 270 to be described later such that the voltage applied to the data line 171 may be prevented from affecting the liquid crystal layer 3.

A light blocking member 220 is disposed on the passivation layer 180 and the shielding electrode 199. The light blocking member 220 is disposed along the gate line 121 and the reference voltage line 131. The light blocking member 220 is referred to as a “black matrix” and prevents light leakage.

Next, the second display panel 200 will be described.

A plurality of color conversion layers 230R and 230G and transmission layers 230B are disposed on one surface of a second substrate 210 made of the insulating material including transmissive glass or plastic. An overcoat 250 is disposed between the plurality of color conversion layers 230R and 230G and transmission layers 230B. The overcoat 250 is disposed on one surface of the plurality of color conversion layers 230R and 230G and transmission layers 230B. Also, a part between the plurality of adjacent color conversion layers 230R and 230G and transmission layers 230B, that is, a boundary part of the plurality of color conversion layers 230R and 230G and transmission layers 230B, overlaps the data line 171 on a plane.

The common electrode 270 receiving a common voltage is disposed on one surface of the overcoat 250.

The plurality of color conversion layers 230R and 230G may emit incident light of different colors, and as one example, the color conversion layers may be a red color conversion layer 230R and a green color conversion layer 230G. The transmission layers 230B may emit incident light without separate color conversion, and as one example, the blue light may be incident and the blue light may be emitted.

The red color conversion layer 230R includes a quantum dot converting the incident blue light into red light, and the green color conversion layer 230G includes a quantum dot converting the incident blue light into green light.

The quantum dot may be selected from a Group II-VI compound, a Group III-V compound, a Group IV-VI compound, a Group IV element, a Group IV compound, and a combination thereof.

The Group II-VI compound may be selected from a two-element compound selected from CdSe, CdTe, ZnS, ZnSe, ZnTe, ZnO, HgS, HgSe, HgTe, MgSe, MgS, and a mixture thereof; a three-element compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a mixture thereof; and a four-element compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a mixture thereof.

The Group III-V compound may be selected from a two-element compound selected from GaN, GaP, GaAs, GaSb, AN, AlP, AlAs, AlSb, InN, InP, InAs, InSb, and a mixture thereof; a three-element compound selected from GaNP, GaNAs, GaNSb, GaPAs, GaPSb, AlNP, AlNAs, AlNSb, AlPAs, AlPSb, InNP, InNAs, InNSb, InPAs, InPSb, and a mixture thereof; and a four-element compound selected from GaAlNAs, GaAlNSb, GaAlPAs, GaAlPSb, GaInNP, GaInNAs, GaInNSb, GaInPAs, GaInPSb, GaAlNP, InAlNP, InAlNAs, InAlNSb, InAlPAs, InAlPSb, and a mixture thereof.

The Group IV-VI compound may be selected from a two-element compound selected from SnS, SnSe, SnTe, PbS, PbSe, PbTe, and a mixture thereof; a three-element compound selected from SnSeS, SnSeTe, SnSTe, PbSeS, PbSeTe, PbSTe, SnPbS, SnPbSe, SnPbTe, and a mixture thereof; and a four-element compound selected from SnPbSSe, SnPbSeTe, SnPbSTe, and a mixture thereof.

The Group IV element may be selected from Si, Ge, and a mixture thereof. The Group IV compound may be a two-element compound selected from SiC, SiGe, and a mixture thereof.

In this case, the two-element compound, the three-element compound, or the four-element compound may be present in particles in uniform concentrations, or may have partially different concentrations in the same particle, respectively. In addition, a core/shell structure in which some quantum dots enclose some other quantum dots may be possible. An interfacing surface between the core and the shell may have a concentration gradient in which a concentration of an element decreases closer to its center.

The quantum dots may have a full width at half maximum (FWHM) of a light-emitting wavelength spectrum of about 45 nm or less, preferably about 40 nm or less, and more preferably about 30 nm or less, and in this range, the color purity or the color reproducibility may be improved. Also, the light emitted through these quantum dots is emitted in all directions, resulting in an improved light viewing angle.

In addition, shapes of the quantum dots are not specifically limited to shapes that are generally used in the related art, but more specifically, it is desirable to use a nanoparticle having a spherical, pyramidal, multi-arm, or cubic shape, and a nanotube, a nanowire, a nanofiber, and a planar nanoparticle may be used.

The transmission layer 230B may be a resin material transmitting the blue light supplied from the light source assembly 500 (referring to FIG. 1). That is, the transmission layer 230B corresponding to the region emitting the blue light emits the incident blue light without the additional quantum dot.

At least one among the plurality of color conversion layers 230R and 230G and transmission layers 230B according to the present exemplary embodiment may include a scattering member 50. For example, the plurality of color conversion layers 230R and 230G and transmission layers 230B may respectively include the scattering member 50. However, the exemplary embodiment is not limited thereto, and the transmission layer 230B may include the scattering member 50 while the red color conversion layer 230R and the green color conversion layer 230G do not include the scattering member 50. Next, an exemplary embodiment in which the plurality of color conversion layers 230R and 230G and transmission layers 230B respectively include the scattering member 50 will be described.

The scattering member 50 scatters light emitted from the quantum dot and allows more light to be emitted, thereby increasing light emission efficiency.

The material of the scattering member 50 may be any material capable of evenly scattering light, and as an example, one among TiO₂, ZrO₂, Al₂O₃, In₂O₃, ZnO, SnO₂, Sb₂O₃, and ITO may be used.

Also, an alignment layer (not shown) may be disposed on an inner surface of the first and second display panels 100 and 200, and the alignment layer may be a vertical alignment layer.

The liquid crystal layer 3 includes a plurality of liquid crystal molecules 31. The liquid crystal molecules 31 may have dielectric anisotropy. The liquid crystal molecules 31 may be aligned such that a major axis thereof is perpendicular to the surfaces of the first and second display panels 100 and 200 in a state where no electric field is applied. In the present exemplary embodiment, the liquid crystal molecules 31 are initially aligned to have a pretilt angle.

At least one of the liquid crystal layer 3 and the alignment layer may include a reactive mesogen (RM). The reactive mesogen may be a photoreactive material, and for example, it may be an ultraviolet ray curable material.

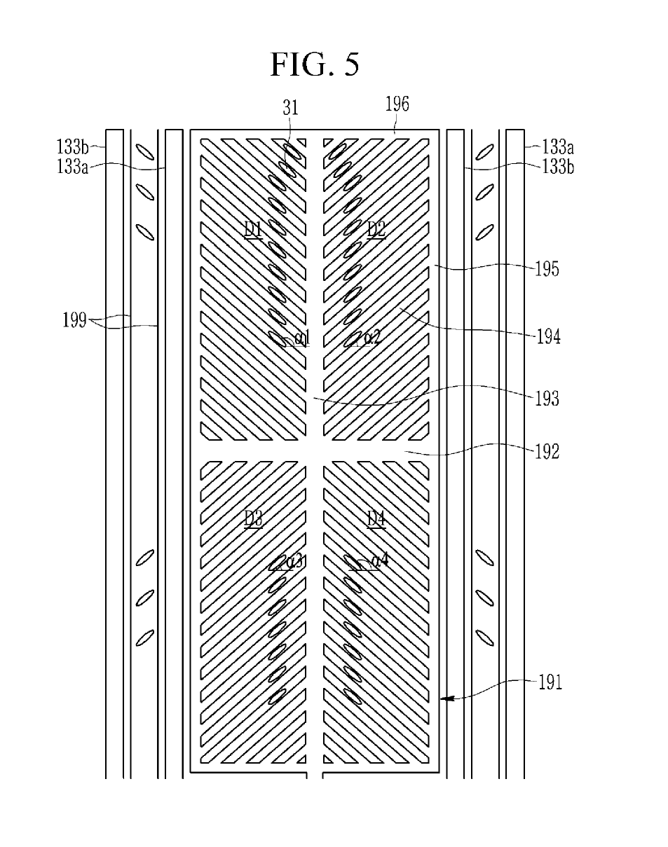

Next, an arrangement direction of the liquid crystal molecules according to an exemplary embodiment of the present invention will be described with reference to FIG. 5.

FIG. 5 is a view schematically showing an arrangement direction of liquid crystal molecules of a liquid crystal display according to an exemplary embodiment of the present invention.

Referring to FIG. 5, the pixel electrode 191 is divided into a first sub-region D1, a second sub-region D2, a third sub-region D3, and a fourth sub-region D4 by the first stem part 192 and the second stem part 193. The first, second, third, and fourth sub-regions D1, D2, D3, and D4 respectively include a plurality of minute branch parts 194 extending to be parallel to each other. The minute branch parts 194 of the first, second, third, and fourth sub-regions Da, Db, Dc, and Dd form an angle of about 45 degrees or 135 degrees with the first stem part 192.

The liquid crystal molecules 31 are arranged in the directions in which the minute branch parts 194 of each of the sub-regions D1, D2, D3, and D4 extend. That is, an angle α1 between the liquid crystal molecules 31 and the first stem part 192 in the first sub-region D1 on a plane is about 135 degrees, and an angle α2 between the liquid crystal molecules 31 and the first stem part 192 in the second sub-region D2 on a plane is about 45 degrees. Also, an angle α3 between the liquid crystal molecules 31 and the first stem part 192 in the third sub-region D3 on a plane is about 45 degrees, and an angle α4 between the liquid crystal molecules 31 and the first stem part 192 in the fourth sub-region D4 on a plane is about 135 degrees.

As described above, a reference viewing angle of the liquid crystal display may be improved by varying the inclined direction of the liquid crystal molecules 31.

Also, the liquid crystal molecules 31 disposed at the part corresponding to the shielding electrode 199 are arranged in the same way as the liquid crystal molecules 31 of each of the sub-regions D1, D2, D3, and D4 of the pixel electrode 191 respectively disposed to be adjacent thereto.

In detail, the liquid crystal molecules 31 disposed at the part corresponding to the shielding electrode 199 disposed adjacent to the first sub-region D1 form the angle of about 135 degrees with the first stem part 192 on a plane like the liquid crystal molecules 31 in the first sub-region D1. The liquid crystal molecules 31 disposed at the part corresponding to the shielding electrode 199 disposed adjacent to the second sub-region D2 form the angle of about 45 degrees with the first stem part 192 on a plane like the liquid crystal molecules 31 in the second sub-region D2. The liquid crystal molecules 31 disposed at the part corresponding to the shielding electrode 199 disposed adjacent to the third sub-region D3 form the angle of about 45 degrees with the first stem part 192 on a plane like the liquid crystal molecules 31 in the third sub-region D3. The liquid crystal molecules 31 disposed at the part corresponding to the shielding electrode 199 disposed adjacent to the fourth sub-region D4 form the angle of about 135 degrees with the first stem part 192 on a plane like the liquid crystal molecules 31 in the fourth sub-region D4.

As described above, because the liquid crystal molecules 31 disposed at the part corresponding to the shielding electrode 199 are arranged in the same way as the liquid crystal molecules 31 of each of the sub-regions D1, D2, D3, and D4 of the pixel electrode 191 respectively disposed to be adjacent thereto, reduction of the transmittance on the edge of the pixel electrode 191 may be prevented.

Now, the manufacturing method of the inventive concepts will be described with reference to FIG. 6A to FIG. 9 and FIG. 1 to FIG. 4.

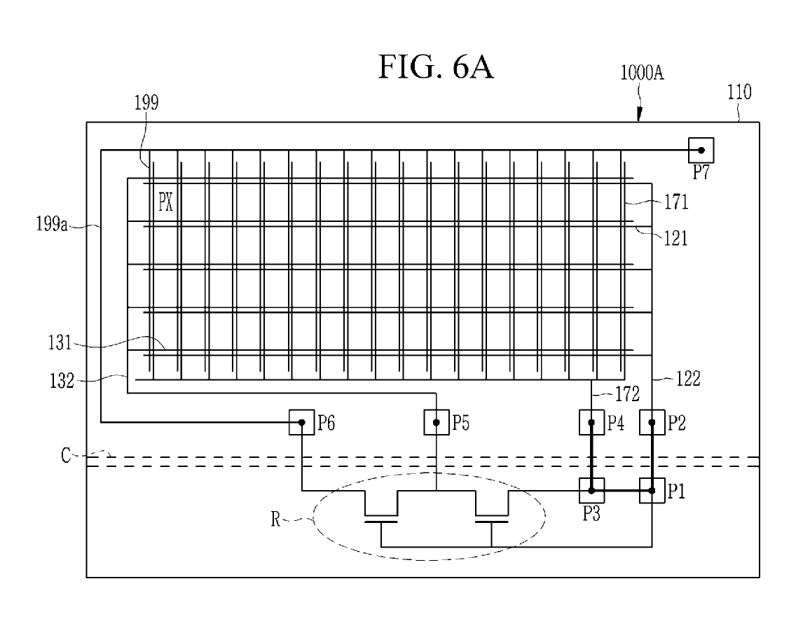

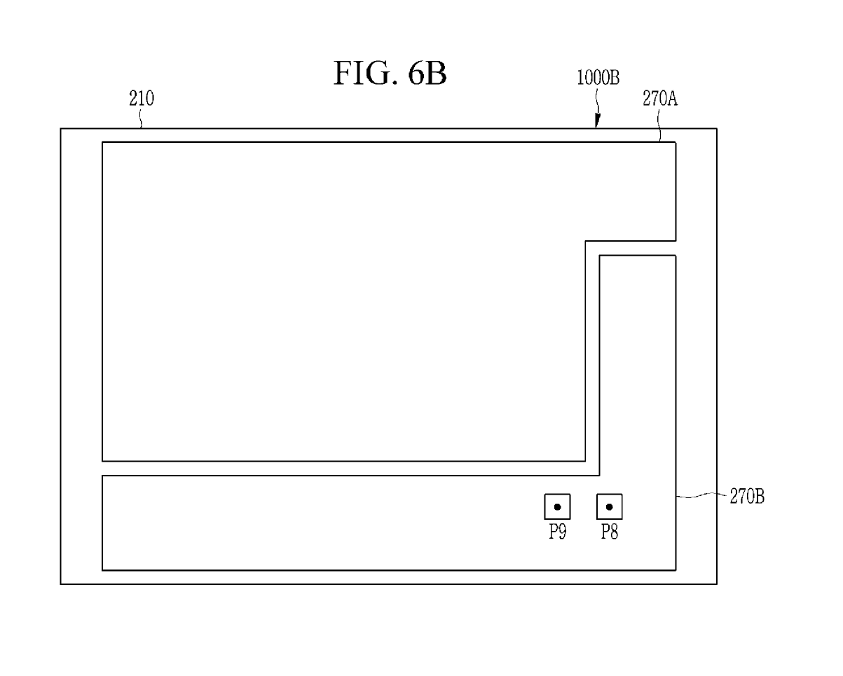

FIG. 6A and FIG. 6B are views schematically shown to explain a method of manufacturing a liquid crystal display according to an exemplary embodiment of the inventive concepts.

FIG. 6A is a view schematically showing a mother glass (hereinafter referred to as a first display mother glass 1000A) to manufacture the first display panel 100 among the liquid crystal panel of FIG. 2, and FIG. 6B is a view schematically showing a mother glass (hereinafter referred to as a second display mother glass 1000B) to manufacture the second display panel 200 among the liquid crystal panel of FIG. 2.

FIG. 6A and FIG. 6B show the first display mother glass 1000A and the second display mother glass 1000B to form one liquid crystal panel, however it is not limited thereto, and a plurality of liquid crystal panels may be formed by the first display mother glass 1000A and the second display mother glass 1000B.

Referring to FIG. 6A and FIG. 6B, the first display mother glass 1000A includes a plurality of thin films disposed on the first substrate 110. Here, the thin films are the constituent elements described above in FIG. 2 to FIG. 4.

A plurality of pixels PX are formed by the gate line 121 and the data line 171. A plurality of pads are disposed outside a region where the pixels PX are formed.

The plurality of pads are disposed on the first substrate 110, and include first to seventh pads P1 to P7. A driving gate line 122, a driving data line 172, a driving reference voltage line 132, and a driving shielding electrode line 199a are disposed on the first substrate 110. A resistor unit R is disposed on the first substrate 110.

The second display mother glass 1000B includes a first common electrode 270A and a second common electrode 270B disposed on the second substrate 210. The first and second common electrodes 270A and 270B are separated from each other. Eighth and ninth pads P8 and P9 are disposed at the second common electrode 270B.

In the manufacturing method of the liquid crystal display according to the present exemplary embodiment, a liquid crystal material is dripped on the first display mother glass 1000A or the second display mother glass 1000B to form the liquid crystal layer after forming the first display mother glass 1000A and the second display mother glass 1000B, and the first display mother glass 1000A and the second display mother glass 1000B are assembled to face the constituent elements formed thereon to each other. Here, the plurality of pixels PX and the first common electrode 270A face each other.

Next, after generating an electric field to the liquid crystal layer 3 between the first and second display mother glasses 1000A and 1000B, light such as ultraviolet rays is irradiated to initially align the liquid crystal molecules 31, and parts of the first and second display mother glasses 1000A and 1000B are cut to complete the liquid crystal panel (referring to FIG. 2 to FIG. 4).

When cutting the first and second display mother glasses 1000A and 1000B, they may be cut along a cutting line C formed on the first display mother glass 1000A. Also, as a result of the cutting of the first and second display mother glasses 1000A and 1000B, the first pad P1, the third pad P3, the eighth pad P8, the ninth pad P9, the second common electrode 270B, and the resistor unit R are removed.

Hereinafter, a plurality of pads will be described in detail.

A first pad P1 and a third pad P3 are disposed outside the cutting line C, and a second pad P2 and fourth to seventh pads P4 to P7 are disposed inside the cutting line C. That is, the first pad P1 and the third pad P3 are disposed at the part that is cut by the cutting of the first and second display mother glasses 1000A and 1000B.

The first pad P1 is electrically connected to the second pad P2. The second pad P2 is connected to the gate line 121 through the driving gate line 122. The third pad P3 is electrically connected to the fourth pad P4. The fourth pad P4 is connected to the data line 171 through the driving data line 172.

The first pad P1 and the third pad P3 are electrically connected.

The fifth pad P5 is electrically connected to the first pad P1 and the third pad P3 through the resistor unit R. Also, the fifth pad P5 is connected to the reference voltage line 131 through the driving reference voltage line 132.

The sixth pad P6 is electrically connected to the first pad P1 and the third pad P3 through the resistor unit R. Also, the sixth pad P6 is connected to the shielding electrode 199 through the driving shielding electrode line 199a. In addition, the sixth pad P6 is connected to the seventh pad P7 through the driving shielding electrode line 199a.

If the first display mother glass 1000A and the second display mother glass 1000B are combined, the eighth and ninth pads P8 and P9 disposed on the second common electrode 270B are respectively and electrically connected to the first pad P1 and the third pad P3. Also, the seventh pad P7 is electrically connected to the first common electrode 270A.

Next, a voltage application to generate the electric field to the liquid crystal layer 3 between the first and second display mother glasses 1000A and 1000B will be described.

After combining the first display mother glass 1000A and the second display mother glass 1000B to face the constituent elements formed thereon to each other, the voltage is applied to the second common electrode 270B by using a pin or a probe for applying the voltage.

Thus, the voltage is respectively applied to the first pad P1 and the third pad P3 through the eighth and ninth pads P8 and P9. Accordingly, the voltage is applied to the gate line 121 and the data line 171.

Also, the voltage applied to the first pad P1 and the third pad P3 is applied to the fifth pad P5 and the sixth pad P6 through the resistor unit R. The voltage applied to the fifth pad P5 is applied to the reference voltage line 131, and the voltage applied to the voltage sixth pad P6 is applied to the shielding electrode 199. Also, the voltage applied to the sixth pad P6 is applied to the first common electrode 270A.

In this case, the resistor unit R includes a plurality of transistors, and as the voltage applied to the first pad P1 and the third pad P3 passes the resistor unit R, a lower voltage is applied to the fifth pad P5 and the sixth pad P6.

Also, the number of transistors of the resistor unit R connected to the fifth pad P5 and the third pad P3 is less than the number of transistors of the resistor unit R connected to the sixth pad P6 and the third pad P3. Accordingly, a voltage that is greater than the voltage applied to the sixth pad P6 is applied to the fifth pad P5.

That is, the voltage applied to the gate line 121 and the data line 171 is greater than the voltage applied to the reference voltage line 131, and the voltage applied to the reference voltage line 131 is greater than the voltage applied to the shielding electrode 199.

As described above, as the voltage is applied to the gate line 121, the data line 171, the reference voltage line 131, and the shielding electrode 199 to generate the electric field to the liquid crystal layer 3 between the first and second display mother glasses 1000A and 1000B, when initially aligning the liquid crystal molecules, the liquid crystal molecules 31 disposed at the part corresponding to the shielding electrode 199 may be arranged like the liquid crystal molecules 31 of each of the sub-regions D1, D2, D3, and D4 of the pixel electrode 191 disposed to be adjacent thereto. Accordingly, reduction of the transmittance on the edge of the pixel electrode 191 may be prevented.

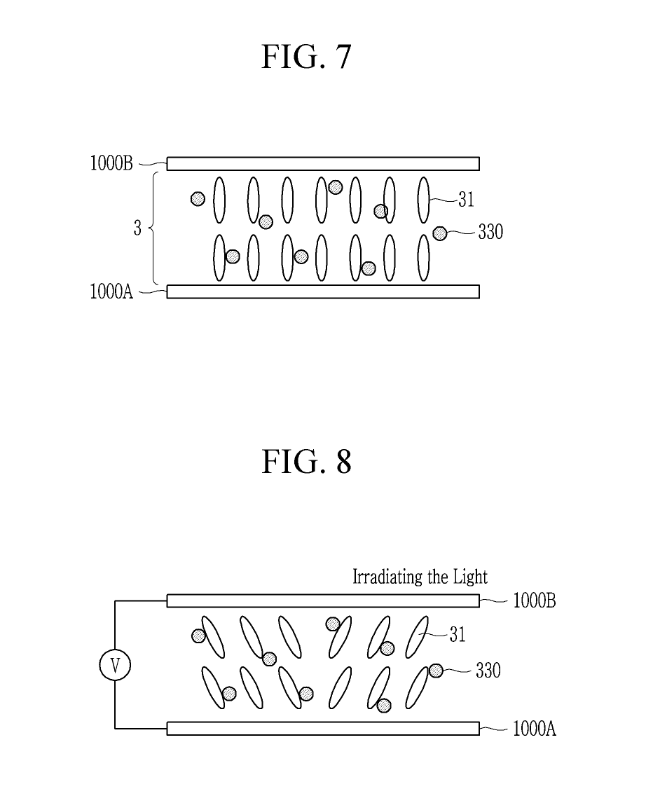

Next, the method of initially aligning the liquid crystal molecules of the liquid crystal layer to have the pretilt angle will be described with reference to FIG. 7 to FIG. 9.

FIG. 7 to FIG. 9 are views schematically showing a process for providing a pretilt to liquid crystal molecules by using prepolymers that are polymerized by light, such as ultraviolet rays. FIG. 7 to FIG. 9 schematically show only the part where the liquid crystal layer 3 is formed among the first and second display mother glasses 1000A and 1000B.

Referring to FIG. 7, prepolymers 330, such as a monomer that is polymerized by light, such as ultraviolet rays, are injected along with a liquid crystal material between the first and second display mother glasses 1000A and 1000B. The prepolymer 330 may be a reactive mesogen that is polymerized by light, such as ultraviolet rays.

Referring to FIG. 8, voltage is applied to the gate line 121, the data line 171, the reference voltage line 131, and the shielding electrode 199 formed at the first display mother glass 1000A to generate the electric field to the liquid crystal layer 3 between the first and second display mother glasses 1000A and 1000B.

In this case, the voltage applied to the data line 171 is applied to the pixel electrode 191 such that the voltage is applied to the pixel electrode 191. The voltage applied to the shielding electrode 199 is applied to the common electrode 270.

Thus, the liquid crystal molecules 31 of the liquid crystal layer 3 are inclined in a direction parallel to the extending direction of the minute branch parts in response to the electric field, as described above, and the liquid crystal molecules 31 in one pixel PX are inclined in a total of four directions.

After generating the electric field to the liquid crystal layer 3, if the light, such as ultraviolet rays, is irradiated, the prepolymers 330 are polymerized to form a polymer 370 as shown in FIG. 8, and the polymer 370 is an alignment layer initially aligning the liquid crystal molecules 31.

The alignment direction of the liquid crystal molecules 31 is determined by the polymer 370 to have a pretilt angle θ in the length direction of the branch electrodes. Accordingly, as shown in FIG. 9, the liquid crystal molecules 31 are arranged while having the pretilt angle θ of four different directions when no voltage is applied to the pixel and common electrodes 191 and 270.

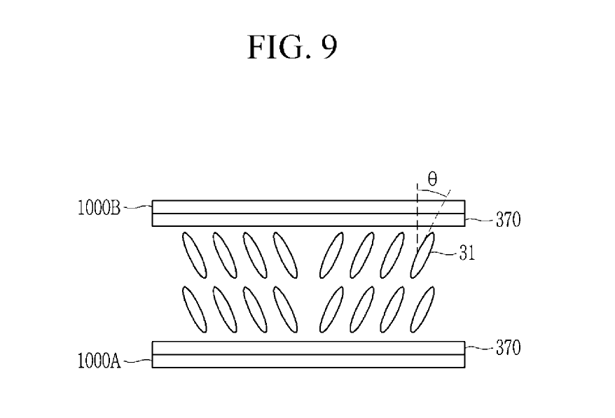

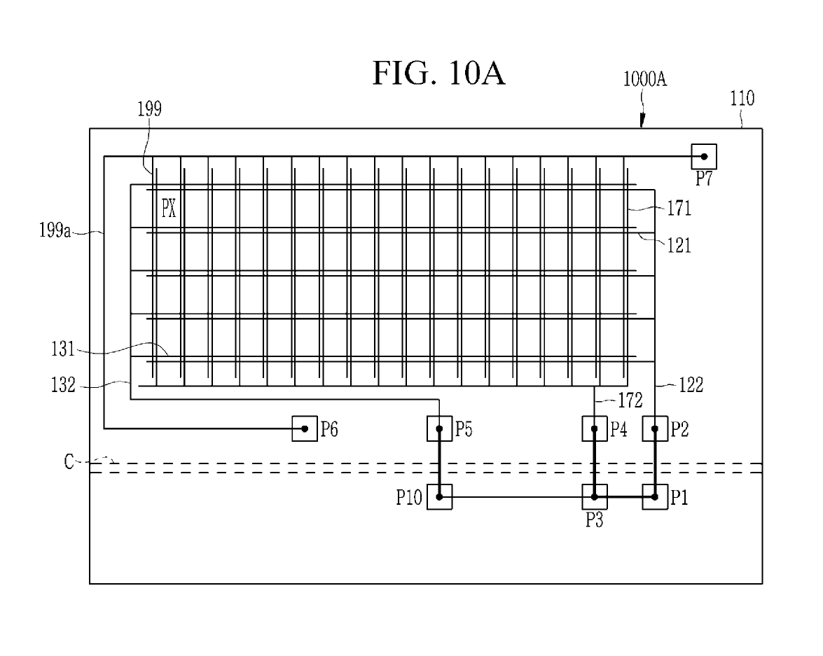

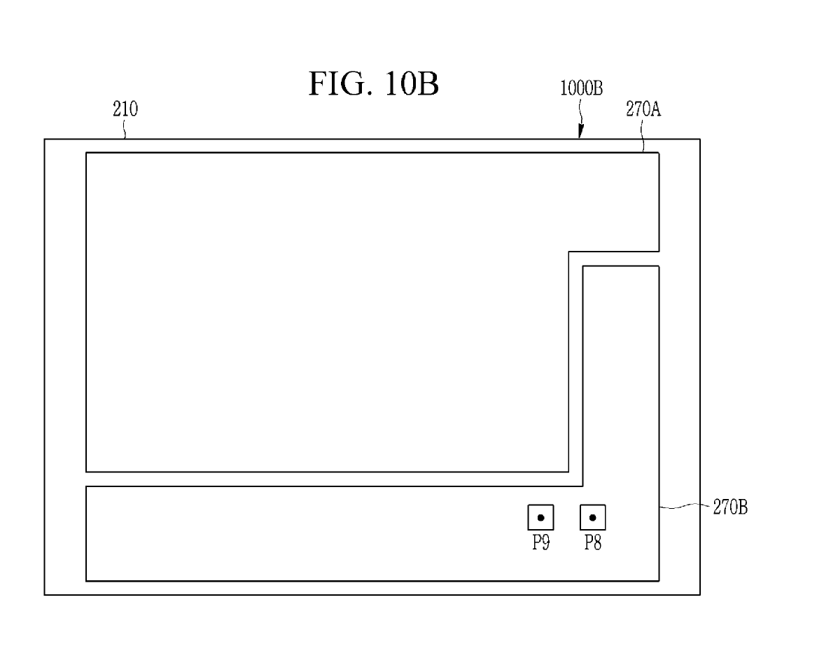

Next, the method of manufacturing the liquid crystal display according to another exemplary embodiment of the inventive concepts will be described with reference to FIG. 10A and FIG. 10B.

Referring to FIG. 10A and FIG. 10B, compared with the method of manufacturing the liquid crystal display according to FIG. 6A and FIG. 6B, the resistor unit is not provided in the first display mother glass 1000A, and the rest of the structure and the manufacturing method thereof are the same except for the voltage application to generate the electric field to the liquid crystal layer 3 between the first and second display mother glasses 1000A and 1000B. Therefore, the description of the same structure and manufacturing method is omitted.

FIG. 10A and FIG. 10B are views schematically shown to explain the method of manufacturing a liquid crystal display according to another exemplary embodiment of the present invention.

FIG. 10A is the view schematically showing the mother glass (hereinafter referred to as the first display mother glass 1000A) to manufacture the first display panel 100 among the liquid crystal panel of FIG. 2, and FIG. 10B is the view schematically showing the mother glass (hereinafter referred to as the second display mother glass 1000B) to manufacture the second display panel 200 among the liquid crystal panel of FIG. 2.

FIG. 10A and FIG. 10B show the first display mother glass 1000A and the second display mother glass 1000B to form one liquid crystal panel, however it is not limited thereto, and the plurality of liquid crystal panels may be formed by the first display mother glass 1000A and the second display mother glass 1000B.

Referring to FIG. 10A and FIG. 10B, differently from the method of manufacturing the liquid crystal display according to FIG. 6A and FIG. 6B, the resistor unit R does not exist, and a tenth pad P10 is disposed on the first substrate 110.

The tenth pad P10 is disposed outside the cutting line C and is electrically connected to the third pad P3. Also, the tenth pad P10 is connected to the reference voltage line 131 through the fifth pad P5.

When cutting the first and second display mother glasses 1000A and 1000B, the first pad P1, the third pad P3, the eighth pad P8, the ninth pad P9, the tenth pad P10, and the second common electrode 270B are removed.

Next, the voltage application to generate the electric field to the liquid crystal layer 3 between the first and second display mother glasses 1000A and 1000B will be described.

After combining the first display mother glass 1000A and the second display mother glass 1000B to face the constituent elements formed thereon to each other, the voltage is applied to the first common electrode 270A and the second common electrode 270B by using the pin or the probe for applying the voltage. In this case, the voltage applied to the first common electrode 270A is less than the voltage applied to the second common electrode 270B.

Thus, the voltage applied to the second common electrode 270B is applied to the first pad P1 and the third pad P3 through the eighth and ninth pad P8 and P9, respectively. Accordingly, the voltage is applied to the gate line 121 and the data line 171.

Also, the voltage applied to the third pad P3 is applied to the reference voltage line 131 through the fifth pad P5.

Further, the voltage applied to the first common electrode 270A is applied to the shielding electrode 199.

That is, the voltage applied to the gate line 121, the data line 171, and the reference voltage line 131 is larger than the voltage applied to the shielding electrode 199.

In this case, the voltage applied to the reference voltage line 131 may affect the initial alignment of the liquid crystal molecules depending the interval between the reference voltage line 131 and the liquid crystal layer 3.

As described above, as the voltage is applied to the gate line 121, the data line 171, the reference voltage line 131, and the shielding electrode 199 to generate the electric field to the liquid crystal layer 3 between the first and second display mother glasses 1000A and 1000B, when initially aligning the liquid crystal molecules, the liquid crystal molecules 31 disposed at the part corresponding to the shielding electrode 199 may be arranged like the liquid crystal molecules 31 of each of the sub-regions D1, D2, D3, and D4 of the pixel electrode 191 disposed to be adjacent thereto. Accordingly, reduction of the transmittance on the edge of the pixel electrode 191 may be prevented.

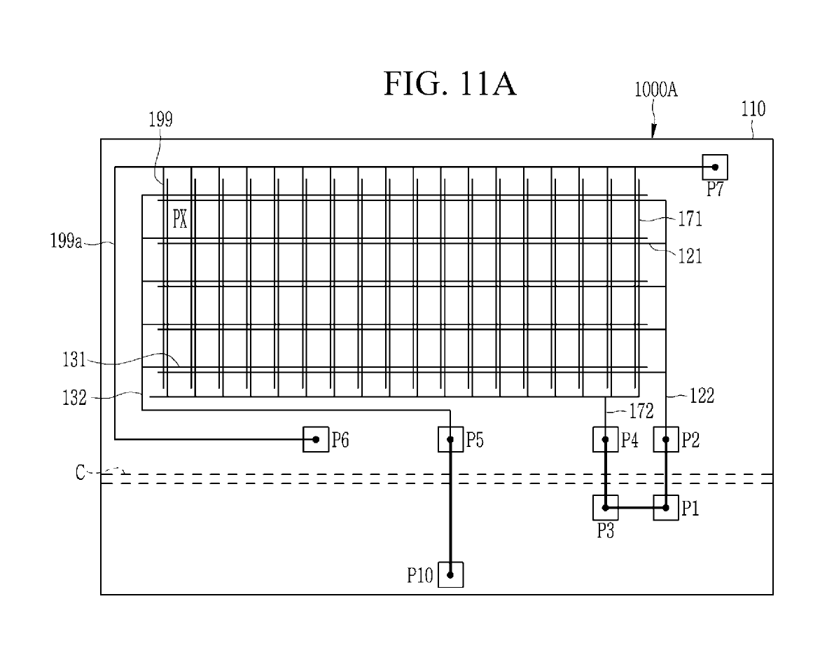

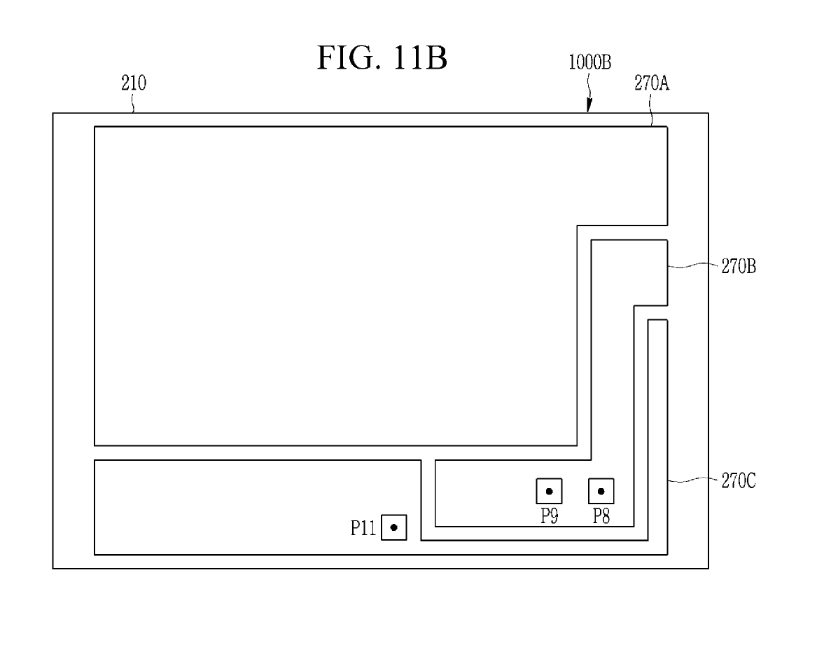

Next, the method of manufacturing the liquid crystal display according to another exemplary embodiment of the inventive concepts will be described with reference to FIG. 11A and FIG. 11B.

Referring to FIG. 11A and FIG. 11B, compared with the method of manufacturing the liquid crystal display according to FIG. 6A and FIG. 6B, the resistor unit is not provided in the first display mother glass 1000A, and the rest of the structure and the manufacturing method thereof are the same except for the voltage application to generate the electric field to the liquid crystal layer 3 between the first and second display mother glasses 1000A and 1000B. Therefore, the description for the same structure and manufacturing method is omitted.

FIG. 11A and FIG. 11B are views schematically shown to explain a method of manufacturing a liquid crystal display according to another exemplary embodiment of the present invention.

FIG. 11A is a view schematically showing the mother glass (hereinafter referred to as the first display mother glass 1000A) to manufacture the first display panel 100 among the liquid crystal panel of FIG. 2, and FIG. 10B is a view schematically showing the mother glass (hereinafter referred to as the second display mother glass 1000B) to manufacture the second display panel 200 among the liquid crystal panel of FIG. 2.

FIG. 11A and FIG. 11B show the first display mother glass 1000A and the second display mother glass 1000B to form one liquid crystal panel, however it is not limited thereto, and the plurality of liquid crystal panels may be formed by the first display mother glass 1000A and the second display mother glass 1000B.

Referring to FIG. 11A and FIG. 11B, differently from the method of manufacturing the liquid crystal display according to FIG. 6A and FIG. 6B, the resistor unit R does not exist, and the tenth pad P10 is disposed on the first substrate 110. Also, the second display mother glass 1000B includes first to third common electrodes 270A, 270B, and 270C separated from each other.

The tenth pad P10 is disposed outside the cutting line C, and is connected to the reference voltage line 131 through the fifth pad P5.

An eleventh pad P11 is disposed at the third common electrode 270C. The eleventh pad P11 is electrically connected to the tenth pad P10 when combining the first display mother glass 1000A and the second display mother glass 1000B.

When cutting the first and second display mother glasses 1000A and 1000B, the first pad P1, the third pad P3, the eighth pad P8, the ninth pad P9, the tenth pad P10, the eleventh pad P11, the second common electrode 270B, and the third common electrode 270C are removed.

Next, the voltage application to generate the electric field to the liquid crystal layer 3 between the first and second display mother glasses 1000A and 1000B will be described.

After combining the first display mother glass 1000A and the second display mother glass 1000B to face the constituent elements formed thereon to each other, the voltage is applied to the first common electrode 270A, the second common electrode 270B, and the third common electrode 270C by using the pin or the probe for applying the voltage. In this case, the voltages applied to the first common electrode 270A, the second common electrode 270B, and the third common electrode 270C are different from each other.

Thus, the voltage applied to the second common electrode 270B is applied to the first pad P1 and the third pad P3 through the eighth and ninth pads P8 and P9, respectively. Accordingly, the voltage is applied to the gate line 121 and the data line 171.

Also, the voltage applied to the third common electrode 270C is applied to the reference voltage line 131 through the eleventh pad P11.

Further, the voltage applied to the first common electrode 270A is applied to the shielding electrode 199.

That is, the voltage applied to the gate line 121 and the data line 171, the voltage applied to the reference voltage line 131, and the voltage applied to the shielding electrode 199 are different from each other.

As described above, as the voltage is applied to the gate line 121, the data line 171, the reference voltage line 131, and the shielding electrode 199 to generate the electric field to the liquid crystal layer 3 between the first and second display mother glasses 1000A and 1000B, when initially aligning the liquid crystal molecules, the liquid crystal molecules 31 disposed at the part corresponding to the shielding electrode 199 may be arranged like the liquid crystal molecules 31 of each of the sub-regions D1, D2, D3, and D4 of the pixel electrode 191 disposed to be adjacent thereto. Accordingly, reduction of the transmittance on the edge of the pixel electrode 191 may be prevented.

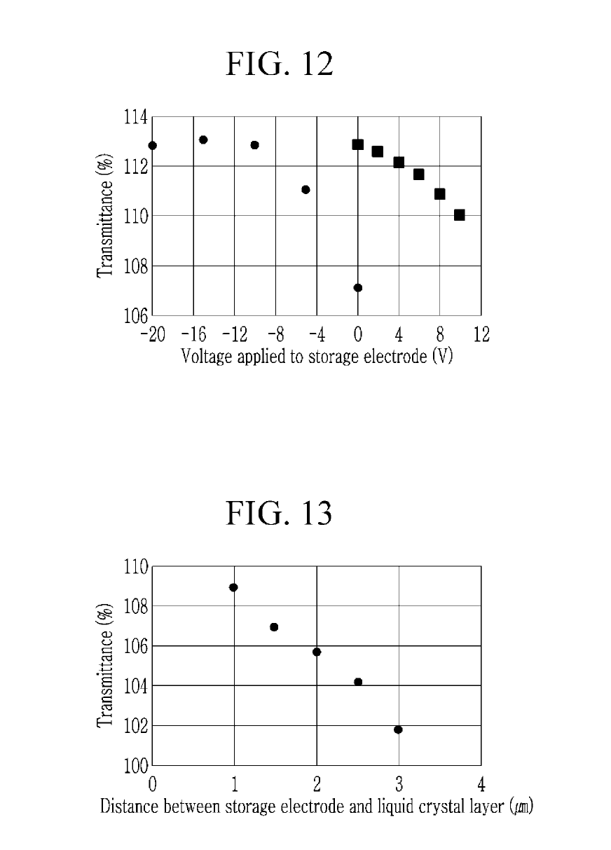

Next, a transmittance characteristic depending on the voltage application when initially aligning the liquid crystal molecules will be described with reference to FIG. 12 and FIG. 13.

FIG. 12 is a graph showing a characteristic of transmittance depending on a voltage application during initial alignment of liquid crystal molecules in a method of manufacturing a liquid crystal display according to FIG. 6A and FIG. 6B, and FIG. 11A and FIG. 11B.

FIG. 13 is a graph showing a characteristic of transmittance depending on a voltage application during initial alignment of liquid crystal molecules in a method of manufacturing a liquid crystal display according to FIG. 10A and FIG. 10B.

In FIG. 12 and FIG. 13, transmittance of 100% indicates transmittance of the liquid crystal display in which a positive (+) voltage is applied to the gate line and the data line, a ground voltage is applied to the shielding electrode, and no voltage is applied to the reference voltage line when initially aligning the liquid crystal molecules.

In FIG. 12, a right-most portion from a position where the voltage applied to the storage electrode of the X-axis is 0 represents the characteristic of the transmittance depending on the voltage application when initially aligning the liquid crystal molecules in the method of manufacturing the liquid crystal display according to FIG. 6A and FIG. 6B, and a left-most portion represents the characteristic of the transmittance according to the voltage application when initially aligning the liquid crystal molecules in the method of manufacturing the liquid crystal display according to FIG. 11A and FIG. 11B.

Referring to FIG. 12, in the method of manufacturing the liquid crystal display according to FIG. 6A and FIG. 6B, when initially aligning the liquid crystal molecules, the transmittance represents 100% or more by the voltage application. FIG. 12 also illustrates that the transmittance decreases as the voltage applied to the storage electrode increases. In this case, a voltage of 8 V is applied to the data line.

In the method of manufacturing the liquid crystal display according to FIG. 11A and FIG. 11B, when initially aligning the liquid crystal molecules, the transmittance is 100% or more by the voltage application. FIG. 12 also illustrates that the transmittance decreases as an absolute value of the voltage applied to the storage electrode decreases. In this case, the voltage of 8 V is applied to the data line and 0 V is applied to the shielding electrode.

Referring to FIG. 13, in the method of manufacturing the liquid crystal display according to FIG. 10A and FIG. 10B, when initially aligning the liquid crystal molecules, the transmittance is 100% or more by the voltage application.

FIG. 13 also illustrates that the transmittance decreases as the distance between the storage electrode and the liquid crystal layer is increased. Also, 18 V is applied to the data line and reference voltage line, and 10 V is applied to the shielding electrode.

While the inventive concepts have been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a liquid crystal panel; and
a light source assembly configured to supply light to the liquid crystal panel,
wherein:
the liquid crystal panel comprises:
a gate line and a data line disposed on a first substrate and insulated from each other;
a transistor connected to the gate line and the data line;
a pixel electrode connected to the transistor;
a second substrate facing the first substrate;
a red color conversion layer, a green color conversion layer, and a transmission layer disposed on one surface of the second substrate;
a common electrode disposed on one surface of the red color conversion layer, the green color conversion layer, and the transmission layer; and
a liquid crystal layer disposed between the first substrate and the second substrate and comprising a plurality of liquid crystal molecules;
the data line is disposed adjacent to one edge of the pixel electrode; and
an arrangement of liquid crystal molecules disposed at a part corresponding to the data line is the same as an arrangement of liquid crystal molecules of a part corresponding to the pixel electrode.

2. The liquid crystal display of claim 1, wherein the pixel electrode comprises:
a first stem part and a second stem part crossing each other;
a minute branch part extending from the first stem part and the second stem part; and
four sub-regions divided by the first stem part and the second stem part.

3. The liquid crystal display of claim 2, wherein the arrangement of liquid crystal molecules disposed at a part corresponding to the data line is the same as an arrangement of liquid crystal molecules disposed at each sub-region of the pixel electrode disposed adjacent to the data line.

4. The liquid crystal display of claim 3, further comprising:
a reference electrode line disposed on the first substrate and disposed on the same layer as and separated from the gate line; and
a shielding electrode disposed on the same layer as the pixel electrode and including the same material as the pixel electrode, and
the shielding electrode overlaps the data line.

5. The liquid crystal display of claim 1, wherein the red color conversion layer and the green color conversion layer comprise quantum dots.

6. The liquid crystal display of claim 5, wherein at least one among the red color conversion layer, the green color conversion layer, and the transmission layer comprises a scattering member.

7. The liquid crystal display of claim 6, wherein the transmission layer does not include the quantum dots.

8. The liquid crystal display of claim 7, wherein the light source assembly supplies blue light to the liquid crystal panel.

9. A method for manufacturing a liquid crystal display, comprising:
forming a first display mother glass comprising a first substrate, a gate line, and a reference voltage line disposed on the first substrate and separated from each other, a data line insulated from the gate line and the reference voltage line, a transistor connected to the gate line and the data line, a pixel electrode connected to the transistor, and a shielding electrode disposed on the same layer as the pixel electrode and separated from the pixel electrode;
forming a second display mother glass comprising a second substrate, and a first common electrode and a second common electrode disposed on the second substrate and separated from each other;
forming a liquid crystal layer comprising a plurality of liquid crystal molecules on the first display mother glass or the second display mother glass;
adhering the first display mother glass and the second display mother glass;
applying a voltage to the first display mother glass and the second display mother glass to form an electric field to the liquid crystal layer; and
irradiating ultraviolet rays to the liquid crystal layer to which the electric field is formed to initially align the liquid crystal molecules,
wherein, when forming the electric field to the liquid crystal layer, a voltage applied to the gate line and the data line is greater than a voltage applied to the reference voltage line, and a voltage applied to the reference voltage line is greater than a voltage applied to the shielding electrode.

10. The method of claim 9, wherein the first display mother glass further comprises:
a first pad, a second pad, a third pad, a fourth pad, a fifth pad, a sixth pad, and a seventh pad disposed on the first substrate;
a resistor unit electrically connected to the third pad;
a driving gate line connecting the second pad and the gate line;
a driving data line connecting the fourth pad and the data line;
a driving reference voltage line connecting the fifth pad and the reference voltage line; and
a driving shielding electrode line connecting the sixth pad and the shielding electrode.

11. The method of claim 10, wherein the second display mother glass further comprises an eighth pad and a ninth pad disposed on the second common electrode.

12. The method of claim 11, wherein:
the first pad is electrically connected to the second pad and the eighth pad;
the third pad is electrically connected to the fourth pad and the ninth pad;
the fifth pad is electrically connected to the third pad through the resistor unit;
the sixth pad is electrically connected to the third pad through the resistor unit;
the sixth pad is electrically connected to the seventh pad through the driving shielding electrode line; and
the seventh pad is electrically connected to the first common electrode.

13. The method of claim 12, wherein:
the resistor unit comprises a plurality of transistors, and
the number of transistors of the resistor unit connected to the fifth pad and the third pad is less than the number of transistors of the resistor unit connected to the sixth pad and the third pad.

14. The method of claim 13, wherein, when forming the electric field to the liquid crystal layer, the voltage is applied to the second common electrode.

15. The method of claim 14, wherein:
the pixel electrode comprises:
a first stem part and a second stem part crossing each other;
a minute branch part extending from the first stem part and the second stem part; and
four sub-regions divided by the first stem part and the second stem part; and
the data line is disposed adjacent to one edge of the pixel electrode.

16. The method of claim 15, wherein, when initially aligning the liquid crystal molecules, an arrangement of liquid crystal molecules disposed at a part corresponding to the data line is the same as an arrangement of liquid crystal molecules disposed at each sub-region of the pixel electrode disposed adjacent to the data line.

17. The method of claim 16, further comprising, after initially aligning the liquid crystal molecules:
cutting a part of the first display mother glass and the second display mother glass; and
when cutting the part of the first display mother glass and the second display mother glass, the first pad, the third pad, the eighth pad, the ninth pad, the second common electrode, and the resistor unit are removed.

18. The method of claim 17, wherein, in the second display mother glass, a red color conversion layer and a green color conversion layer disposed between the second substrate and the first common electrode comprise quantum dots.

19. The method of claim 18, wherein at least one among the red color conversion layer, the green color conversion layer, and a transmission layer comprises a scattering member.

20. The method of claim 19, wherein the transmission layer does not include the quantum dots.
